(19) United States
(12) Patent Application Publication
(10) Pub. No.: US 2010/0291862 A1
(43) Pub. Date: Nov. 18, 2010

(54) BROADCASTING SATELLITE RECEIVING CONVERTER IC, BROADCASTING SATELLITE RECEIVING CONVERTER, AND BROADCASTING SATELLITE RECEIVING ANTENNA

(76) Inventors: Takeshi Mitsunaka, Osaka (JP); Masahiko Maruyama, Osaka (JP)

Correspondence Address: BIRCH STEWART KOLASCH & BIRCH, PO BOX 747, FALLS CHURCH, VA, 22040-0747, US

(21) Appl. No.: 12/727,397

(22) Filed: Mar. 19, 2010

(30) Foreign Application Priority Data
May 15, 2009 (JP) 2009-118915

(51) Int. Cl. H04H 20/74; H04B 1/16

(52) U.S. Cl. 455/3.02; 455/343.1

(57) ABSTRACT

A broadcasting satellite receiving converter IC includes a switch circuit and a voltage generating source. Disposed in front of the broadcasting satellite receiving converter IC are two first amplifying circuits which amplify differently polarized BS signals, respectively, and a second amplifying circuit. The switch circuit receives, from a BS tuner, a DC voltage signal for controlling switching of polarized signals to be received, and detects the strength of the received DC voltage signal, thereby determining which of the first amplifying circuits to use. Depending on the strength of the DC voltage signal detected by the switch circuit, the voltage generating source supplies either the first amplifying circuits and the second amplifying circuit with positive and negative voltages through a plurality of terminals.

This Nonprovisional application claims priority under 35 U.S.C. §119(a) on Patent Application No. 2009-118915 filed in Japan on May 15, 2009, the entire contents of which are hereby incorporated by reference.

### TECHNICAL FIELD

The present invention relates to a broadcasting satellite receiving converter IC having both a PLL circuit and a frequency converting circuit formed on a semiconductor substrate. More particularly, the present invention relates to a broadcasting satellite receiving converter (BS converter) IC including a circuit that supplies negative and positive voltages to low noise amplifying circuits disposed in front of the IC.

### BACKGROUND ART

The reception frequency band used in a BS system has been widened along with digitalization, an increase in the number of channels, and so on. Taking the reception frequency band between 10.7 GHz and 12.75 GHz as an example, reception of a number of channels is made possible by dividing the frequency band into a low frequency band of 10.7 GHz to 11.7 GHz and a high frequency band of 11.7 GHz to 12.75 GHz as well as receiving a horizontally-polarized wave and a vertically-polarized wave. It is thus necessary to provide two independent antenna terminals so as to respectively receive a horizontally-polarized wave and vertically-polarized wave.

Non-Patent Literature 1 discloses a BS converter configured to house horizontally-polarized wave receiving means and vertically-polarized wave receiving means, and to switch between the horizontally-polarized wave receiving means and the vertically-polarized wave receiving means so that a BS signal divided into a horizontally-polarized wave and a vertically-polarized wave is received by a single antenna and a single BS converter. Such a BS converter includes a switching circuit for switching between the horizontally-polarized wave receiving means and the vertically-polarized wave receiving means depending on, for example, the level of a supply voltage from a BS tuner connected to the BS converter.

The BS signals received by the BS converter are converted into intermediate frequency signals (BS-IF signals) of 1.5 GHz that can be transmitted through a cable, and then supplied to an interior BS tuner.

Patent Literature 1 discloses a BS converter that includes a switching circuit that switches, in accordance with a band switching pulse signal of 22 KHz superimposed on a power supply voltage from a BS tuner connected to the BS converter, oscillation frequencies of frequency converting local oscillators incorporated in the BS converter.

### Citation List

Patent Literature 1

Japanese Patent Application Publication, Tokukai 2005-347975 A (published on Dec. 15, 2005)

Non-Patent Literature 1

G. Girlando and three others, “A Ku-Band Monolithic Tuner-LNB for Satellite Applications”, IEEE 2004 CUSTOM INTEGRATED CIRCUITS CONFERENCE, 28-3-1 to 28-3-4

### SUMMARY OF INVENTION

### Technical Problem

In a broadcasting satellite reception system, a signal received by a parabola antenna is converted into an intermediate frequency signal by a broadcasting satellite receiving converter (hereinafter referred to as “BS converter”) of a low noise block downconverter (hereinafter referred to as “LNB”) provided in the antenna, and then transmitted to a set top box (hereinafter referred to as “BS tuner”) through a cable.

An LNB includes a low-noise high-electron-mobility transistor (hereinafter referred to as “HEMT”) made of GaAs and/or other materials, a frequency converting circuit, a local oscillator, and so on. In addition, the LNB is supplied with a power supply and a control signal by the BS tuner through a cable, and a negative is produced by e.g. a high-frequency field-effect transistor (GaAs-FET) incorporated in the LNB.

A BS converter illustrated in FIG. 5 includes a broadcasting satellite receiving converter IC 40, high-frequency amplifying circuits 51 and 52 each composed of an HEMT, an amplifying circuit 53 also composed of an HEMT, and switching circuits 54 and 55.

The broadcasting satellite receiving converter IC 40 is composed of an amplifying circuit 41 (e.g. a low noise amplifier), a frequency converting circuit 42, an output amplifying circuit 43, a local oscillator 44, and a PLL circuit (phase-locked loop circuit) 45 that are on a semiconductor substrate. The high-frequency amplifying circuits 51 and 52 are low-noise high-electron-mobility transistors that amplify a horizontally-polarized signal and a vertically-polarized signal. The amplifying circuit 53 further amplifies the output of the high-frequency amplifying circuit 51 or 52. The switching circuit 54 determines which of the high-frequency amplifying circuits 51 and 52 to use, depending on the level of the supply voltage from a BS tuner. A switching circuit 55 switches the oscillation frequency of the local oscillator 44 in accordance with a band switching pulse signal of 22 KHz superimposed on the power supply voltage from the BS tuner.

Meanwhile, the above-described BS converter includes at least components such as the broadcasting satellite receiving converter IC 40, the switching circuits 54 and 55, and the HEMTs 51 to 53. Moreover, the switching circuits 54 and 55 are separate from the broadcasting satellite receiving converter IC 40. Therefore, in the case where the gains of HEMTs are too high, it is impossible to add an AGC (automatic gain control) function and the like to detect the strength of an internal signal and adjust the value of a negative voltage. Thus, there has been a problem in realizing this function that an increase in the number of components is likely and therefore a disadvantage in cost reduction is brought.

The present invention has been made in view of the above problem, and it is an object of the present invention to provide a broadcasting satellite receiving converter that makes it possible that a BS signal divided into e.g. a horizontally-polarized wave and a vertically-polarized wave is received by a single antenna and a single BS converter, with a reduction in the number of components.

### SOLUTION TO PROBLEM

In order to solve the foregoing problem, a broadcasting satellite receiving converter IC of the present invention is a broadcasting satellite receiving converter IC formed on a semiconductor substrate, including: a voltage generating circuit, provided on the semiconductor substrate, which generates and outputs plural types of negative voltages having different voltage values.

According to the above-described structure, in a broadcasting satellite receiving converter in which low noise amplifying circuits are disposed in front of the broadcasting satellite receiving converter IC, it is possible, for example, that gate voltages of HEMTs used as the low noise amplifying circuits are controlled by the voltage generating circuit provided in the broadcasting satellite receiving converter IC. This makes it unnecessary to provide another voltage generating circuit outside the IC chip to control the HEMTs, and makes it possible to curb the number of components.

### ADVANTAGEOUS EFFECTS OF INVENTION

As described above, the broadcasting satellite receiving converter IC of the present invention is a broadcasting satellite receiving converter IC formed on a semiconductor substrate, including: a voltage generating circuit, provided on the semiconductor substrate, which generates and outputs plural types of negative voltages having different voltage values.

This makes it unnecessary to provide e.g. another voltage generating circuit outside the IC chip to control the HEMTs and the like, and makes it possible to curb the number of components.

### BRIEF DESCRIPTION OF DRAWINGS

FIG. 1

FIG. 1 is a block diagram illustrating an embodiment of the present invention including a broadcasting satellite receiving converter IC 1.

FIG. 2

FIG. 2 is a block diagram illustrating another embodiment of the present invention including a broadcasting satellite receiving converter IC 1.

FIG. 3

FIG. 3 is a block diagram illustrating yet another embodiment of the present invention including a broadcasting satellite receiving converter IC 1.

FIG. 4

FIG. 4 is a block diagram illustrating yet another embodiment of the present invention including a broadcasting satellite receiving converter IC 1.

FIG. 5

FIG. 5 is a block diagram including a conventional broadcasting satellite receiving converter IC 40.

FIG. 6

FIG. 6 is a block diagram illustrating yet another embodiment of the present invention including a broadcasting satellite receiving converter IC 40.

### DESCRIPTION OF EMBODIMENTS

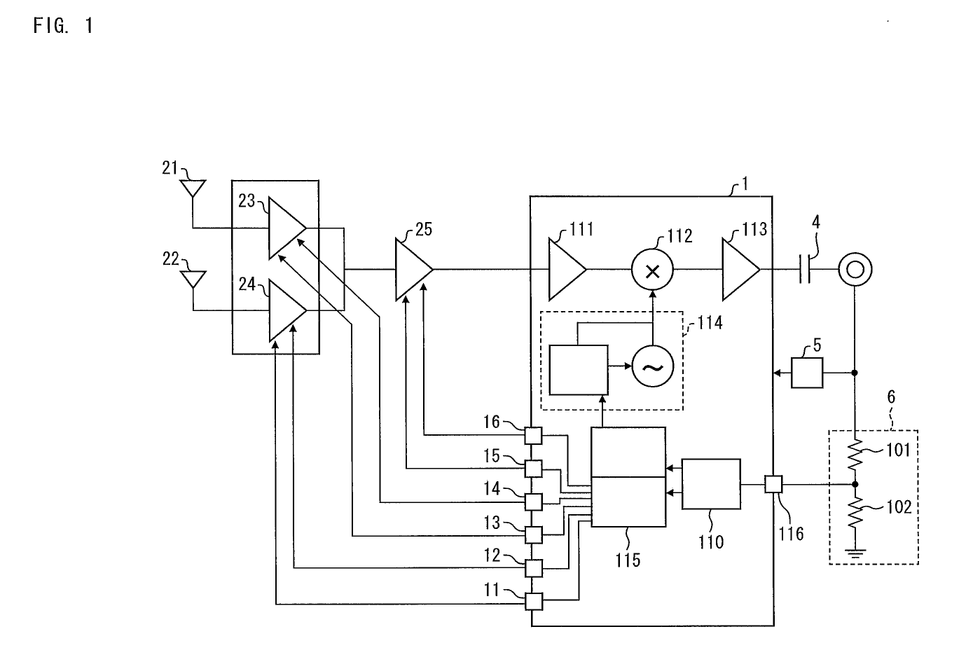

Embodiment 1 of the present invention is described in detail below. FIG. 1 is a block diagram illustrating a broadcasting satellite receiving converter IC according to Embodiment 1 of the present invention including a negative voltage generating circuit.

A horizontally-polarized BS signal or a vertically-polarized BS signal received by a parabola antenna (not illustrated) is inputted from BS signal terminals 21 and 22. Disposed behind the BS signal terminals 21 and 22 are first amplifying circuits 23 and 24 and a second amplifying circuit 25. The first amplifying circuits 23 and 24 amplify the horizontally-polarized BS signal and the vertically-polarized BS signal inputted from the BS signal terminals 21 and 22, respectively. Then, the second amplifying circuit 25 further amplifies an output of either the first amplifying circuit 23 or 24.

The amplifying circuits 23 to 25 are low-noise high-frequency amplifying circuits, composed of high-electron-mobility transistors (HEMTs) or the like, which operate at a high frequency. In order for the amplifying circuit 23 or 24 to receive either a horizontally-polarized BS signal or a vertically-polarized BS signal, it is necessary to selectively switch voltages that are to he supplied to these amplifying circuits. Therefore, the voltages that are to be supplied to the amplifying circuit 23 or 24 are selectively switched by a switch circuit 110 incorporated in the broadcasting satellite receiving converter IC 1. In other words, depending on whether the received BS signal is horizontally polarized or vertically polarized, the amplifying circuit 23 or 24 is supplied with necessary voltages from terminals 11 and 12 or from terminals 13 and 14. Meanwhile, the second amplifying circuit 25 is supplied with necessary voltages from terminals 15 and 16 consistently during the reception of a BS signal so as to amplify either the horizontally-polarized BS signal or the vertically-polarized BS signal.

The output of the amplifying circuit 25 is further amplified by an amplifying circuit 111 incorporated in the broadcasting satellite receiving converter IC 1, and then converted by a frequency converting circuit 112 into a BS-IF signal which is an intermediate frequency signal. The BS-IF signal is further amplified by a subsequent amplifying circuit 113. After that, a capacitor 4 eliminates a DC component from the BS-IF signal, and the BS-IF signal is sent to a BS tuner (not illustrated) through a cable (not illustrated).

A PLL circuit 114 includes a local oscillating circuit, and outputs a local oscillating signal at a reception frequency band of 10.7 GHz to 12.75 GHz so as to convert a low frequency band of 10.7 GHz to 11.7 GHz and a high frequency band of 11.7 GHz to 12.75 GHz into a BS-IF frequency.

The switch circuit 110 receives, from the BS tuner, a DC voltage signal for controlling switching of polarized waves to be received. That is, the switch circuit 110 receives either a DC voltage signal of 13 volts or 18 volts that serves also as a power supply voltage. The switch circuit 110 detects the strength of the received DC voltage signal, thereby determining which of the first amplifying circuits 23 and 24 to use.

A voltage generating source 115, which generates positive voltages and negative voltages depending on the level of the voltage of the DC voltage signal detected by the switch circuit 110, supplies either the amplifying circuit 23 or 24 and the amplifying circuit 25 with the positive voltages and the negative voltages through the terminals 11 to 16.

High-electron-mobility transistors (HEMTs) used for the amplifying circuits 23 to 25 generally operate by supplying a negative voltage to the gate terminal and a positive voltage to the drain terminal. For example, in the case where the amplifying circuit 23 is used, the broadcasting satellite receiving converter IC 1 generates a negative voltage at the terminal 13 and supplies it to the gate terminal of the HEMT. Simultaneously, the broadcasting satellite receiving converter IC 1 generates a positive voltage at the terminal 14 and supplies it to the drain terminal of the HEMT. Here, the HEMT used as amplifying circuit 24 is not in use, and thus supplied from the terminals 11 and 12 with voltages at which the HEMT does not operate.

In the above-described structure, the output signal of the amplifying circuit 23 is supplied to the amplifying circuit 25. The amplifying circuit 25, which operates in the same manner as the amplifying circuit 23, is supplied with a negative voltage outputted from the terminal 15 of the broadcasting satellite receiving converter IC 1 to the gate terminal of the HEMT. At the same time, a positive voltage outputted from the terminal 16 is supplied to the drain terminal of the HEMT. Thus, a BS signal amplified by the amplifying circuit 25 is supplied to the amplifying circuit 111 of the broadcasting satellite receiving converter IC 1.

In the case where the amplifying circuit 24 is used, the broadcasting satellite receiving converter IC 1 generates a negative voltage at the terminal 11 and supplies it to the gate terminal of the HEMT. Simultaneously, the broadcasting satellite receiving converter IC 1 generates a positive voltage at the terminal 12 and supplies it to the drain terminal of the HEMT. Here, the HEMT used as the amplifying circuit 23 is not in use, and thus supplied with voltages at which the HEMT does not operate.

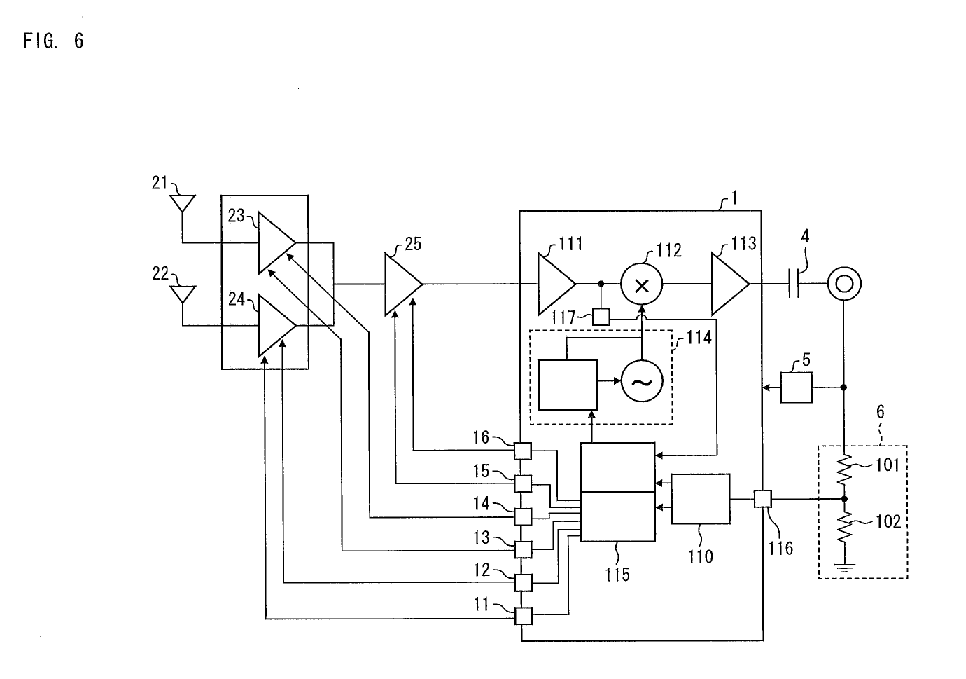

As already stated, in the case where the amplifying circuit 23 is used, the HEMT used as the amplifying circuit 24 is supplied with the voltages at which the HEMT does not operate. However, as shown in FIG. 6, when an AGC circuit 117, which detects an output signal of the amplifying circuit 111 incorporated in the broadcasting satellite receiving converter IC 1, is provided so as to control an output voltage from the voltage generating source 115, a gate voltage of the HEMT used as the amplifying circuit 23 is controlled. This enables the broadcasting satellite receiving converter IC 1 to additionally have a function of controlling a gain of the HEMT used as the amplifying circuit 23.

In a broadcasting satellite receiving converter according to the present embodiment, a switch circuit 110 for switching between amplifying circuits 23 and 24 is provided in a broadcasting satellite receiving converter IC 1. In other words, the broadcasting satellite receiving converter IC 1 includes a circuit that generates a negative voltage for causing the amplifying circuit 23 or 24 to operate to receive either a horizontally-polarized BS signal or a vertically-polarized BS signal. This makes it unnecessary to provide a switch circuit outside the chip substrate of the broadcasting satellite receiving converter IC 1, and makes it possible to reduce the number of components in comparison with that of a conventional BS converter. Moreover, since the AGC function makes it possible to easily control the gate voltages of HEMTs, the gains of the HEMTs can he easily controlled.

If the maximum rated voltage of a semiconductor substrate used for the broadcasting satellite receiving converter IC 1 is lower than a DC voltage signal of 13 volts or 18 volts that controls switching of polarized waves and serves also as a power supply voltage, a regulator 5 is provided. The regulator 5 regulates the power supply voltage of 13 volts or 18 volts to be a power supply voltage that complies with the maximum rated voltage of the semiconductor substrate, and inputs it to the broadcasting satellite receiving converter IC 1.

Meanwhile, a voltage producing circuit 6 composed of resistors 101 and 102 is provided outside the broadcasting satellite receiving converter IC 1 and divides the power supply voltage. In other words, the power supply voltage of 13 volts or 18 volts is divided by the resistors 101 and 102 so as to be lowered to a level within the maximum rated voltage of the semiconductor substrate. The voltage lowered through the division is inputted to the switch circuit 110 via a switch control signal input terminal 116.

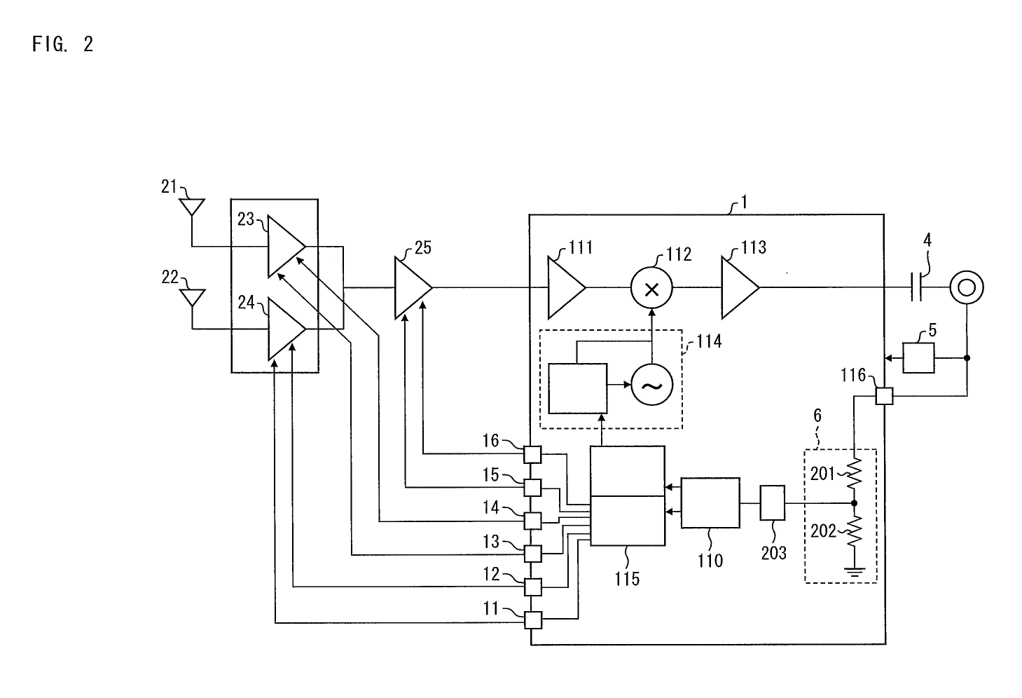

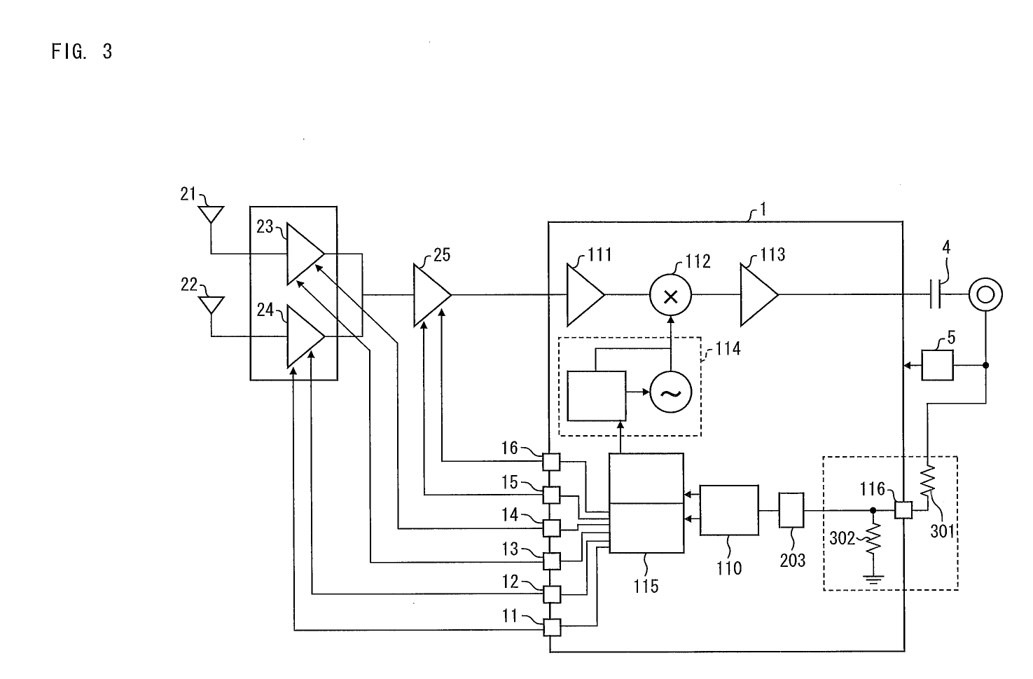

Alternatively, the above voltage dividing resistors may be provided inside the broadcasting satellite receiving converter IC 1 as illustrated in FIG. 2, or they may be provided inside and outside the broadcasting satellite receiving converter IC as illustrated in FIG. 3. In FIG. 2, the power supply voltage is connected to the switch control signal input terminal 116 and by resistors 201 and 202 incorporated in the broadcasting satellite receiving converter IC 1. The power supply voltage is then connected to the switch circuit 110 via an ESD (electro static discharge) element 203. In contrast, in FIG. 3, only a resistor 301 is connected outside the broadcasting satellite receiving converter IC 1, and a resistor 302 is incorporated in the broadcasting satellite receiving converter IC 1. The power supply voltage is divided by the resistors 301 and 302.

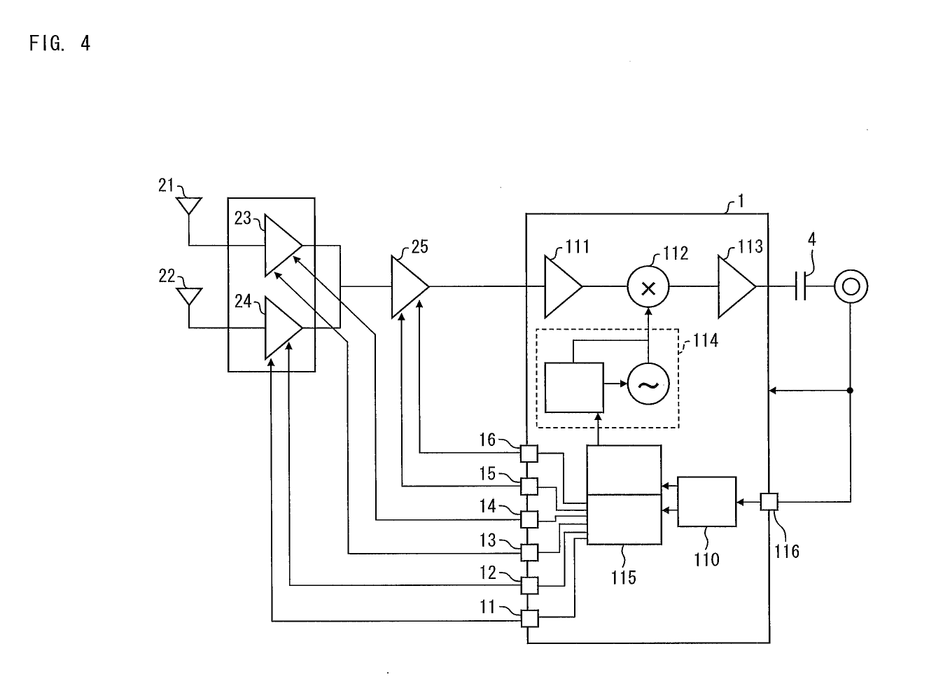

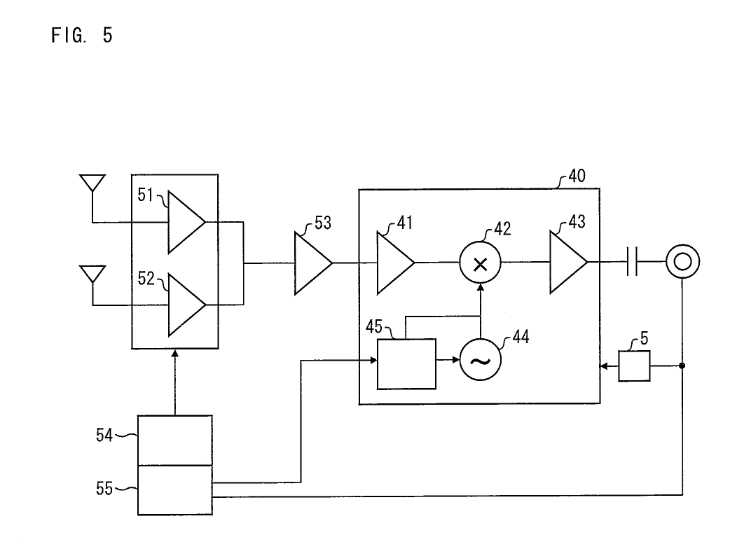

If the maximum rated voltage of a semiconductor substrate used for the broadcasting satellite receiving converter IC 1 is sufficiently higher than a DC voltage signal of 13 volts or 18 volts that controls switching of polarized waves and serves also as a power supply voltage, the aforementioned voltage dividing resistors and the external regulator 5 may be omitted. Such a structure is illustrated in FIG. 4.

Moreover, it is also possible to incorporate, into the broadcasting satellite receiving converter IC 1 thus structured, a regulator 5 that supplies necessary voltages to the amplifying circuits 111 and 113, the frequency converting circuit 112, the PLL circuit 114, and so on. Furthermore, the switch circuit 110 is capable of detecting the power supply voltage of 13 volts or 18 volts directly i.e. without the intervening voltage dividing resistors 101 and 102.

According to the above-described structures, it is possible to configure a BS converter with a small number of components, centered around a broadcasting satellite receiving converter IC 1, thus contributing to cost reduction. Furthermore, according to the above-described structure, it is possible to configure a broadcasting satellite receiving antenna centered around a broadcasting satellite receiving converter with a small number of components, thus contributing to cost reduction.

The description of the present embodiment focuses solely on the switching between a horizontally-polarized wave and a vertically-polarized wave. However, it should be noted that there is also a circularly-polarized wave, and that the present invention is applicable to switching between a right-hand circularly-polarized wave and a left-hand circularly-polarized wave as well.

A broadcasting satellite receiving converter IC of the present invention is a broadcasting satellite receiving converter IC formed on a semiconductor substrate, including: a voltage generating circuit, provided on the semiconductor substrate, which generates and outputs plural types of negative voltages having different voltage values.

According to the above-described structure, in a broadcasting satellite receiving converter in which low noise amplifying circuits are disposed in front of the broadcasting satellite receiving converter IC, it is possible, for example, that gate voltages of HEMTs used as the low noise amplifying circuits are controlled by the voltage generating circuit provided in the broadcasting satellite receiving converter IC. This makes it unnecessary to provide another voltage generating circuit outside the IC chip to control the HEMTs, and makes it possible to curb the number of components.

In addition, the above-described broadcasting satellite receiving converter IC is configured to further include: a switch circuit that switches, in accordance with a polarized wave switching signal transmitted from a broadcasting satellite receiving tuner connected to the broadcasting satellite receiving converter IC, the negative voltages to be outputted by the voltage generating circuit.

According to this structure, in a broadcasting satellite receiving converter in which low noise amplifiers are disposed in front of the broadcasting satellite receiving converter IC, it is possible to output negative voltages to each of the low noise amplifying circuits as needed.

In addition, the above-described broadcasting satellite receiving converter IC may be configured such that: the voltage generating circuit further generates and outputs plural types of positive voltages having different voltage values; and the switch circuit switches, in accordance with a polarized wave switching signal transmitted from the broadcasting satellite receiving tuner connected to the broadcasting satellite receiving converter IC, the negative voltages and positive voltages to be outputted by the voltage generating circuit.

According to this structure, for example, it is possible to switch, as needed, drain voltages as well as gate voltages of HEMTs used as the low noise amplifying circuits.

Moreover, the above-described broadcasting satellite receiving converter IC may be configured such that: the voltage generating circuit generates not only negative voltages that are able to be switched by the switch circuit but also a negative voltage that is consistently able to be outputted.

According to this structure, for example, another low noise amplifying circuit that is consistently in operation is disposed behind the low noise amplifying circuits that are supplied with the negative voltages that are able to be switched by the switch circuit. This makes it possible to also control the gate voltage of the low noise amplifying circuit that is consistently in operation.

Furthermore, the above-described broadcasting satellite receiving converter IC may be configured such that: the switch circuit detects strength of a voltage signal supplied by a broadcasting satellite receiving tuner and switches, in accordance with the strength of the voltage signal, negative voltages to be outputted.

According to this structure, in a broadcasting satellite receiving converter in which low noise amplifying circuits are disposed in front of the broadcasting satellite receiving converter IC, it is possible to determine which of the low noise amplifying circuits to use.

In order to solve the foregoing problem, a broadcasting satellite receiving converter of the present invention includes: such a broadcasting satellite receiving converter IC as described above; and at least two low noise amplifying circuits that are supplied with negative voltages generated by the broadcasting satellite receiving converter IC, the low noise amplifying circuits amplifying BS signals received in different states of polarization.

According to this structure, it is possible that gate voltages of HEMTs used as the low noise amplifying circuits are controlled by the voltage generating circuit provided in the broadcasting satellite receiving converter IC. This makes it unnecessary to provide another voltage generating circuit outside the IC chip of the BS converter IC to control the HEMTs, and makes it possible to curb the number of components.

In addition, the above-described broadcasting satellite receiving converter may be configured such that: a voltage signal supplied by a broadcasting satellite receiving tuner is divided by voltage dividing resistors and inputted to the switch circuit as a voltage that complies with a rated voltage of the broadcasting satellite receiving converter IC.

According to this structure, even when the voltage of the voltage signal supplied by the broadcasting satellite tuner is higher than the rated voltage of the broadcasting satellite converter IC, a voltage that does not exceed the rated voltage can be inputted to a switch circuit of the broadcasting satellite converter IC by dividing the voltage signal.

Moreover, the above-described broadcasting satellite receiving converter may be configured such that: the voltage dividing resistors are on the same semiconductor substrate as the broadcasting satellite receiving converter IC and a divided voltage that is connected to an ESD element.

This structure makes it possible to incorporate even the voltage dividing resistors into a broadcasting satellite receiving converter IC, thus making it possible to curb the number of components.

The present invention is not limited to the description of the embodiments above, but may be altered within the scope of the claims. An embodiment based on a proper combination of technical means disclosed in different embodiments is encompassed in the technical scope of the present invention.

### REFERENCE SIGNS LIST

1 Broadcasting satellite receiving converter IC
5 Regulator
6 Voltage producing circuit
23, 24 First amplifying circuits (low noise amplifying circuits)
25 Second amplifying circuit (low noise amplifying circuit)
110 Switch circuit
112 Frequency changing circuit
114 PLL circuit
115 Voltage generating source (voltage generating circuit)
101, 102 Voltage dividing resistors
203 ESD element

1. A broadcasting satellite receiving converter IC formed on a semiconductor substrate, comprising:
a voltage generating circuit, provided on the semiconductor substrate, which generates and outputs plural types of negative voltages having different voltage values.

2. The broadcasting satellite receiving converter IC according to claim 1, further comprising:
a switch circuit that switches, in accordance with a polarized wave switching signal transmitted from a broadcasting satellite receiving tuner connected to the broadcasting satellite receiving converter IC, the negative voltages to be outputted by the voltage generating circuit.

3. The broadcasting satellite receiving converter IC according to claim 2, wherein:
the voltage generating circuit further generates and outputs plural types of positive voltages having different voltage values; and
the switch circuit switches, in accordance with a polarized wave switching signal transmitted from the broadcasting satellite receiving tuner connected to the broadcasting satellite receiving converter IC, the negative voltages and the positive voltages to be outputted by the voltage generating circuit.

4. The broadcasting satellite receiving converter IC according to claim 2, wherein:
the voltage generating circuit generates not only negative voltages that are able to be switched by the switch circuit but also a negative voltage that is consistently able to be outputted.

5. The broadcasting satellite receiving converter IC according to claim 2, wherein the switch circuit detects strength of a voltage signal supplied by a broadcasting satellite receiving tuner and switches, in accordance with the strength of the voltage signal, negative voltages to be outputted.

6. A broadcasting satellite receiving converter comprising:
a broadcasting satellite receiving converter IC according to claim 1; and
at least two low noise amplifying circuits that are supplied with negative voltages generated by the broadcasting satellite receiving converter IC,
the low noise amplifying circuits amplifying broadcasting satellite signals received in different states of polarization, respectively.

7. A broadcasting satellite receiving converter comprising:
a broadcasting satellite receiving converter IC according to claim 5; and
at least two low noise amplifying circuits that are supplied with negative voltages generated by the broadcasting satellite receiving converter IC,
the low noise amplifying circuit amplifying broadcasting satellite signals received in different states of polarization, respectively,
a voltage signal supplied by a broadcasting satellite receiving tuner being divided by voltage dividing resistors and inputted to the switch circuit as a voltage that complies with a rated voltage of the broadcasting satellite receiving converter IC.

8. The broadcasting satellite receiving converter according to claim 7, wherein the voltage dividing resistors are on the same semiconductor substrate as the broadcasting satellite receiving converter IC and forms a divided voltage that is connected to an ESD element.

9. A broadcasting satellite receiving antenna comprising a broadcasting satellite receiving converter according to claim 6.
